(19) United States
(12) Patent Application Publication
(10) Pub. No.: US 2022/0245764 A1
(43) Pub. Date: Aug. 4, 2022

(54) METHOD FOR IMAGE SUPER-RESOLUTION, DEVICE AND STORAGE MEDIUM

(71) Applicant: Beijing Baidu Netcom Science Technology Co., Ltd., Beijing (CN)

(72) Inventors: Qi ZHANG, Beijing (CN); Kangyi ZHI, Beijing (CN)

(21) Appl. No.: 17/723,201

(22) Filed: Apr. 18, 2022

(30) Foreign Application Priority Data
Sep. 30, 2021 (CN) 202111159704.X

(51) Int. Cl. G06T 3/40; G06N 3/08

(52) U.S. Cl. CPC G06T 3/4053; G06N 3/08; G06T 3/4046

(57) ABSTRACT

A method for an image super-solution, a device and a storage medium are provided. The method may include: acquiring training samples, where the training samples include a first-resolution sample image and a corresponding second-resolution sample image, and a resolution of the second-resolution sample image is N times a resolution of the sample of first resolution, N being a positive integer; and training an initial network model by using the first-resolution sample image as an input and using the second-resolution sample image as an output, to obtain the super-resolution model.

### CROSS-REFERENCE TO RELATED APPLICATIONS

The present application claims the priority of Chinese Patent Application No. 202111159704.X, titled “METHOD AND APPARATUS FOR IMAGE SUPER-RESOLUTION, DEVICE, STORAGE MEDIUM, AND PROGRAM PRODUCT”, filed on Sep. 30, 2021, the content of which is incorporated herein by reference in its entirety.

### TECHNICAL FIELD

The present disclosure relates to the field of artificial intelligence, specifically to the technologies of computer vision and deep learning, and may be specifically applied to a scenario of image processing.

### BACKGROUND

Image super-resolution, as an important technology in the field of image processing and computers, aims to convert a low-resolution image into a high-resolution image. A conventional method for image super-resolution is to perform up-sampling on images, and resolution upscaling is basically performed based on interpolation.

### SUMMARY

Embodiments of the present disclosure provides a method for an image super-resolution, a device and a storage medium.

According to a first aspect, embodiments of the present disclosure provide a method for training a super-resolution model, and the method includes: acquiring training samples, where the training samples include a first-resolution sample image and a corresponding second-resolution sample image, and a resolution of the second-resolution sample image is N times a resolution of the first resolution sample image, N being a positive integer; and training an initial network model by using the first-resolution sample image as an input and using the second-resolution sample image as an output, to obtain the super-resolution model.

According to a second aspect, embodiments of the present disclosure provide a method for an image super-resolution, and the method includes: acquiring a first-resolution target image; and inputting the first-resolution target image into a super-resolution model to obtain a second-resolution target image, where a resolution of the second-resolution target image is N times a resolution of the first-resolution target image, and the super-resolution model is trained by using the method as described in the first aspect.

According to a third aspect, embodiments of the present disclosure provide a method for an image super-resolution, and the method includes: acquiring a first-resolution target image; and performing a search in a lookup table based on the first-resolution target image to obtain a second-resolution target image, where a resolution of the second-resolution target image is N times a resolution of the first-resolution target image, and the lookup table is generated by using the method as described in the first aspect.

According to a fourth aspect, embodiments of the present disclosure provide an electronic device, and the device includes: at least one processor; and a memory communicatively connected to the at least one processor, where the memory stores instructions executable by the at least one processor, and the instructions, when executed by the at least one processor, cause the at least one processor to execute the method as described in any one of the first aspect, the second aspect and the third aspect.

According to a fifth aspect, embodiments of the present disclosure provide a non-transitory computer readable storage medium storing computer instructions, where the computer instructions when executed by a computer cause the computer to execute the method as described in any one of the first aspect, the second aspect and the third aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

After reading detailed descriptions of non-limiting embodiments with reference to the following accompanying drawings, other features, objectives and advantages of the present disclosure will become more apparent. The accompanying drawings are used for better understanding of the present solution, and do not impose any limitation on the present disclosure. In the accompanying drawings:

FIG. 1 is a flowchart of a first embodiment of a method for training a super-resolution model according to the present disclosure;

FIG. 2 is a schematic structural diagram of a super-resolution model;

FIG. 3 is a flowchart of a second embodiment of a method for training a super-resolution model according to the present disclosure;

FIG. 4 is a flowchart of a third embodiment of a method for training a super-resolution model according to the present disclosure;

FIG. 5 is a flowchart of a first embodiment of a method for an image super-resolution according to the present disclosure;

FIG. 6 is a flowchart of a second embodiment of a method for an image super-resolution according to the present disclosure;

FIG. 7 is a flowchart of a third embodiment of a method for an image super-resolution according to the present disclosure;

FIG. 8 is a flowchart of a fourth embodiment of a method for an image super-resolution according to the present disclosure;

FIG. 9 is a schematic structural diagram of a first embodiment of an apparatus for training a super-resolution model according to the present disclosure;

FIG. 10 is a schematic structural diagram of a first embodiment of an apparatus for an image super-resolution according to the present disclosure;

FIG. 11 is a schematic structural diagram of a second embodiment of an apparatus for an image super-resolution according to the present disclosure;

FIG. 12 is a block diagram of an electronic device configured to implement a method for training a super-resolution model or a method for an image super-resolution according to embodiments of the present disclosure.

### DETAILED DESCRIPTION OF EMBODIMENTS

Example embodiments of the present disclosure are described below with reference to the accompanying drawings, where various details of embodiments of the present disclosure are included to facilitate understanding, and should be considered merely as examples. Therefore, those of ordinary skills in the art should realize that various alterations and modifications can be made to embodiments described here without departing from the scope and spirit of the present disclosure. Similarly, for clearness and conciseness, descriptions of well-known functions and structures are omitted in the following description.

It should be noted that embodiments in the present disclosure and the features in the embodiments may be combined with each other on a non-conflict basis. The present disclosure will be described in detail below with reference to the accompanying drawings and in combination with the embodiments.

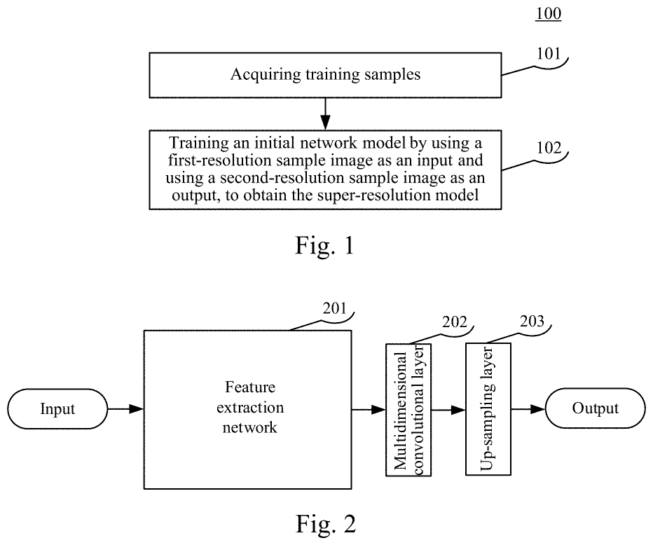

FIG. 1 shows a flow 100 of a first embodiment of a method for training a super-resolution model according to the present disclosure. The method for training a super-resolution model includes the following steps 101 and 102.

Step 101 includes acquiring training samples.

In this embodiment, the execution body of the method for training a super-resolution model may acquire a large number of training samples. The training samples may include a first-resolution sample image and a corresponding second-resolution sample image. A resolution of the second-resolution sample image may be N times a resolution of the first-resolution sample image, and N is a positive integer. That is, an image content of the first-resolution sample image is the same as an image content of the second-resolution sample image, but the resolution of the second-resolution sample image is higher than the resolution of the first-resolution sample image.

Generally, the training samples may be acquired in a variety of ways. In practice, in order to ensure that the trained super-resolution model can output a clearer image, it is required that the second-resolution sample image does not lose information compared with the first-resolution sample image, and has a higher definition. For example, a second-resolution sample image is acquired by a high-resolution camera, and down-sampling is performed on the second-resolution sample image to obtain a corresponding first-resolution sample image. For another example, images of a given static object, i.e., a first-resolution sample image and a corresponding second-resolution sample image, are acquired at a given position and at a given angle by using a low-resolution camera and a high-resolution camera respectively.

Step 102 includes training an initial network model by using the first-resolution sample image as an input and using the second-resolution sample image as an output, to obtain the super-resolution model.

In this embodiment, the execution body may train the initial network model by using the first-resolution sample image as the input and using the second-resolution sample image as the output, to obtain the super-resolution model.

Generally, the super-resolution model may be obtained by performing supervised training on the initial network model by using a machine learning method and training samples. In practice, various parameters (e.g., a weight parameter and an offset parameter) of the initial network model may be initialized with some different small random numbers. “Small random number” is used to ensure that the network does not enter a saturation state due to a too large weight, thereby causing the training to fail. “Different” is used to ensure that the network can learn normally. The parameters of the initial network model may be continuously adjusted during the training process until the trained model can output a high-resolution image with a sufficient definition based on a low-resolution image. For example, the parameters of the initial network model may be adjusted by using a BP (Back Propagation) algorithm or a SGD (Stochastic Gradient Descent) algorithm.

According to the method for training a super-resolution model provided by embodiments of the present disclosure, the super-resolution model is obtained by training using the first-resolution sample image as the input, and using the second-resolution sample image as the output, the resolution of the second-resolution sample image being N times the resolution of the first resolution sample image. The trained super-resolution model can recover more information that has been lost, so that an output image is clearer.

For ease of understanding, FIG. 2 shows a schematic structural diagram of a super-resolution model. As shown in FIG. 2, the super-resolution model may include a feature extraction network 201, a multidimensional convolutional layer 202, and an up-sampling layer 203. The feature extraction network 201 may be, for example, a convolutional neural network for extracting a feature map. A dimension of the multidimensional convolutional layer 202 is equal to N and can be used to convolve an input such that a number of channels of an output is N² times a number of a channel of the input. When N=2, the multidimensional convolutional layer 202 may be, for example, Conv2d. The up-sampling layer 203 may be, for example, a Pixel-shuffle for converting a channel dimension into a spatial dimension.

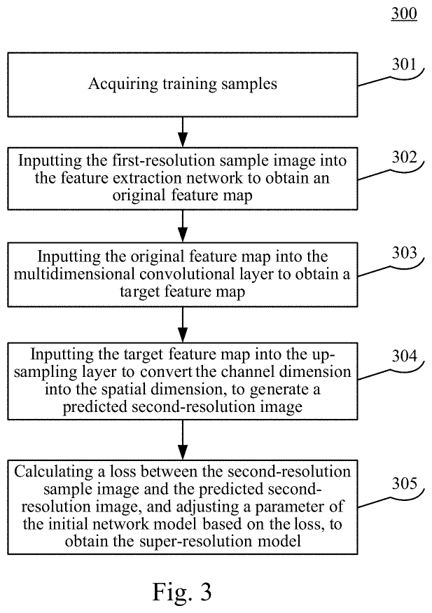

Continuing to refer FIG. 3, a flow 300 of a second embodiment of a method for training a super-resolution model according to the present disclosure is shown. The method for training a super-resolution model includes the following steps 301 to 305.

Step 301 includes acquiring training samples.

In this embodiment, the specific operation of step 301 is described in detail in step 101 of the embodiment shown in FIG. 1, and is not repeated herein.

Step 302 includes inputting the first-resolution sample image into the feature extraction network to obtain an original feature map.

In this embodiment, the execution body of the method for training a super-resolution model may input the first-resolution sample image into the feature extraction network to obtain the original feature map. The feature extraction network may be, for example, a convolutional neural network for extracting a feature map.

Step 303 includes inputting the original feature map into the multidimensional convolutional layer to obtain a target feature map.

In this embodiment, the execution body may input the original feature map into the multidimensional convolutional layer to obtain the target feature map. A dimension of the multidimensional convolutional layer is equal to N and can be used to convolve the input such that a number of channels of an output (the target feature map) is N² times a number of a channel of an input (the original feature map). When N=2, the multidimensional convolutional layer may be, for example, Conv2d. If the number of the channel of the original feature map is 1, the number of channels of the target feature map is 4.

Step 304 includes inputting the target feature map into the up-sampling layer to convert the channel dimension into the spatial dimension, to generate a predicted second resolution image.

In this embodiment, the execution body may input the target feature map into the up-sampling layer to convert the channel dimension into the spatial dimension, to generate the predicted second resolution image. The up-sampling layer may be, for example, a Pixel-shuffle for converting a channel dimension into a spatial dimension. For example, for a 4×H×W target feature map, the up-sampling layer may convert the 4×H×W target feature map into a 1×2H×2 W predicted second resolution image, thereby achieving resolution upscaling. Here, 4 is the number of channels of the target feature map, H is the height of the target feature map, and W is the width of the target feature map. 1 is the number of the channel of the predicted second resolution image, 2H is the height of the predicted second resolution image, and 2 W is the width of the predicted second resolution image.

Step 305 includes calculating a loss between the second-resolution sample image and the predicted second resolution image, and adjusting a parameter of the initial network model based on the loss, to obtain the super-resolution model.

In this embodiment, the execution body may calculate the loss between the second-resolution sample image and the predicted second resolution image, and adjust the parameter of the initial network model based on the loss, to obtain the super-resolution model.

Generally, the execution body may input the second-resolution sample image and the predicted second resolution image into a loss function to obtain a loss. The parameter of the initial network model is adjusted based on the loss, and the super-resolution model may be obtained until a loss is sufficiently small and the model converges. Here, an approach for determining a loss by using a loss function is a well-known technique that is widely studied and applied at present, and is not described in detail herein. The parameter of the initial network model may be adjusted by using the BP algorithm or the SGD algorithm.

As can be seen from FIG. 3, the flow 300 of the method for training a super-resolution model in this embodiment highlights the steps of training the model, compared with the corresponding embodiment of FIG. 1. Thus, the super-resolution model in the solution described in this embodiment includes a feature extraction network, a multidimensional convolutional layer, and an up-sampling layer. The multidimensional convolutional layer may increase a number of channels of an output, and the up-sampling layer may convert the channel dimension into a spatial dimension, thereby enabling the trained super-resolution model to upscale the resolution. Moreover, the trained super-resolution model reduces information loss and makes the output image clearer.

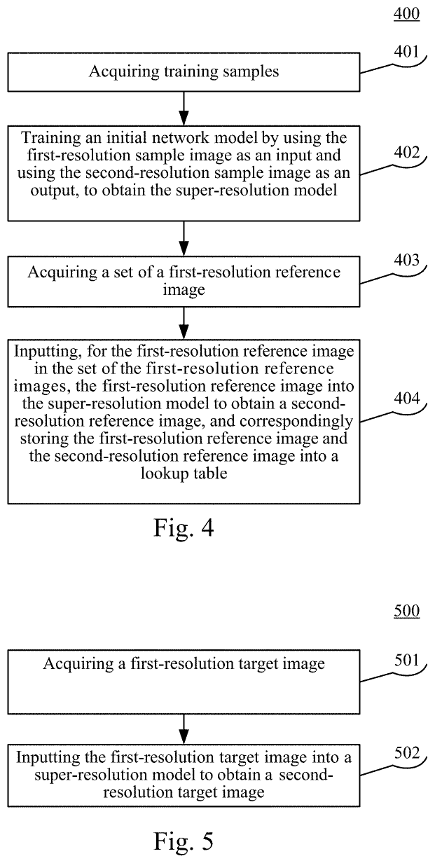

Referring further to FIG. 4, a flow 400 of a third embodiment of a method for training a super-resolution model according to the present disclosure is shown. The method for training a super-resolution model includes the following steps 401 to 404.

Step 401 includes acquiring training samples.

Step 402 includes training an initial network model by using the first-resolution sample image as an input and using the second-resolution sample image as an output, to obtain the super-resolution model.

In this embodiment, the specific operations of steps 401 and 402 are described in detail in steps 101 and 102 of the embodiment shown in FIG. 1, and are not repeated herein.

Step 403 includes acquiring a set of first-resolution reference images.

In this embodiment, the execution body of the method for training a super-resolution model may acquire the set of the first-resolution reference images. The set of first-resolution reference images may include first-resolution reference images obtained by arbitrarily combining values of pixels of an image. Generally, a size of a receptive field of the super-resolution model is fixed. For example, if the receptive field is 4, it means that a pixel value of a certain position on the output image is related to four corresponding pixel points on the input image. The first-resolution reference image in the set of the first-resolution reference images may be an image consisting of four pixel points, and therefore the set may include 255×255×255×255 first-resolution reference images.

Step 404 includes inputting, for the first-resolution reference image in the set of the first-resolution reference images, the first-resolution reference image into the super-resolution model to obtain a second-resolution reference image, and correspondingly storing the first-resolution reference image and the second-resolution reference image into a lookup table.

In this embodiment, the execution body may input, for the first-resolution reference images in the set of the first-resolution reference images, the first-resolution reference images into the super-resolution model to obtain the second-resolution reference images, and correspondingly storing the first-resolution reference images and the second-resolution reference images into the lookup table. Here, a resolution of a second-resolution reference image is N times a resolution of a first-resolution reference image. Since the set of the first-resolution reference images includes 255×255×255×255 first-resolution reference images, a size of the lookup table is 255×255×255×255, and is about 64G. In order to reduce the size of the lookup table, the set of the first-resolution reference images may be further quantized. For example, a preset quantization table is acquired, where quantization values in the preset quantization table are an equal-ratio sequence with a common ratio of M. The quantization values in the preset quantization table are selected as pixel values for arbitrary combinations to generate the set of the first-resolution reference images. For example, if the quantization values in the preset quantization table are an equal-ratio sequence with a common ratio of 16, the pixel values of 0-255 may be quantized as 0, 16, 32, . . . , 255, so that the set of the first-resolution reference images includes 17×17×17×17 first-resolution reference images, and therefore the size of the lookup table is 17×17×17×17, and is about 1.25M. The set of the first-resolution reference images that is input into the super-resolution model has a number of 17×17×17×17×1×2×2, and the set of the second-resolution reference images that is output from the super-resolution model has a number of 17×17×17×17×1×4×4, and a table having a shape of L and having a number of 17×17×17×17×4×4, i.e., the lookup table, is stored.

As can be seen from FIG. 4, the flow 400 of the method for training a super-resolution model in this embodiment adds the steps of generating the lookup table, compared with the corresponding embodiment of FIG. 1. Thus, the solution described in this embodiment generates the lookup table based on the super-resolution model, so that an image super-resolution can be performed based on the lookup table. The deployment of the lookup table-based method is more flexible, and there is no need to deploy a model for an actual prediction.

Referring further to FIG. 5, a flow 500 of a first embodiment of a method for an image super-resolution according to the present disclosure is shown. The method for an image super-resolution includes the following steps 501 and 502.

Step 501 includes acquiring a first-resolution target image.

In this embodiment, the execution body of the method for an image super-resolution may acquire the first-resolution target image. The first-resolution target image may be a low-resolution image.

Here, the first-resolution target image is generally an 8 bit 3-channel image. For an image that is not an 8 bit image, the image may be quantized to 8 bit. Further, in order to reduce the amount of calculation, pixel values of pixel points on the first-resolution target image may be quantized. In the case where the first-resolution target image is an 8 bit image, there are 255 quantization values. For example, the pixel values of 0-255 may be quantized as 0, 16, 32, . . . , 255.

Step 502 includes inputting the first-resolution target image into a super-resolution model to obtain a second-resolution target image.

In this embodiment, the execution body may input the first-resolution target image into the super-resolution model to obtain the second-resolution target image. A resolution of the second-resolution target image is N times a resolution of the first-resolution target image. The super-resolution model is trained by using the embodiment of the method shown in FIG. or FIG. 2. The super-resolution model can recover more information that has been lost, thereby making the output second-resolution target image clearer.

It should be noted that the execution body of the method for training a super-resolution model may be the same as or different from the execution body of the method for an image super-resolution. For example, the method for training a super-resolution model and the method for an image super-resolution are both performed by a server. For another example, the method for training a super-resolution model is performed by a server. The trained super-resolution model is stored on a terminal, and the method for an image super-resolution is performed by the terminal. The testing is separated from the training.

According to the method for an image super-resolution provided by embodiments of the present disclosure, the second-resolution target image is predicted by using the super-resolution model, so that more information that has been lost can be recovered, and the output second-resolution target image is clearer.

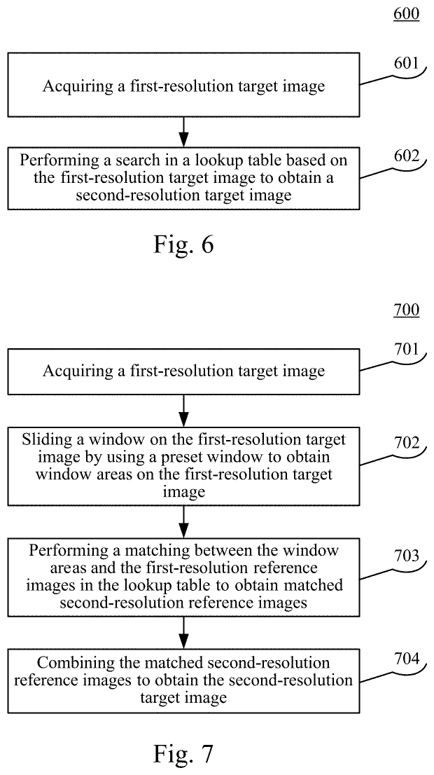

Referring further to FIG. 6, a flow 600 of a second embodiment of a method for an image super-resolution according to the present disclosure is shown. The method for an image super-resolution includes the following steps 601 and 602.

Step 601 includes acquiring a first-resolution target image.

In this embodiment, the execution body of the method for an image super-resolution may acquire the first-resolution target image. The first-resolution target image may be a low-resolution image.

Here, the first-resolution target image is generally an 8 bit 3-channel image. For an image that is not an 8 bit image, the image may be quantized to 8 bit. Further, in order to reduce the amount of calculation, pixel values of pixel points on the first-resolution target image may be quantized. In the case where the first-resolution target image is an 8 bit image, there are 255 quantization values. For example, the pixel values of 0-255 may be quantized as 0, 16, 32, . . . , 255.

It should be noted that the first-resolution target image and the set of the first-resolution reference images may be quantized in the same manner.

Step 602 includes performing a search in a lookup table based on the first-resolution target image to obtain a second-resolution target image.

In this embodiment, the execution body may perform the search in the lookup table based on the first-resolution target image to obtain a second-resolution target image. For example, if the first-resolution target image is an image consisting of four pixel points, a matching is performed between the first-resolution target image and the set of the first-resolution reference images, a second-resolution reference image in the lookup table is obtained as the second-resolution target image, where the second-resolution reference image corresponding to the first-resolution reference image matches the first-resolution target image. A resolution of the second-resolution target image is N times a resolution of the first-resolution target image. The lookup table may be generated by using the embodiment of the method shown in FIG. 3.

It should be noted that the execution body of the method for training a super-resolution model may be the same as or different from the execution body of the method for an image super-resolution. For example, the method for training a super-resolution model and the method for an image super-resolution are both performed by a server. For another example, the method for training a super-resolution model is performed by a server. The generated lookup table is stored on a terminal, and the method for an image super-resolution is performed by the terminal. The testing is separated from the training, and the training process do not directly convert a low-resolution image into a high-resolution image, but obtains parameters of a model and converts the model into a lookup table, and therefore the training may use a more complex model to obtain a better lookup table without changing a duration of testing. A super-resolution algorithm is transplanted to the terminal and tested on the terminal, so that more bandwidth cost and storage cost are saved, and a better visual experience can be brought to the user. Moreover, short video products have a demand for a super-resolution, since making a clearer video is a very common demand and people always tend to obtain more information. If the super-resolution is performed on the terminal, a low-resolution video can be directly delivered to the terminal, and then the low-resolution video becomes a high-resolution video by performing the super-resolution on the terminal. The calculation is performed on the terminal, so that the storage cost and the bandwidth cost can be reduced. In the present video era, there is a very large application scenario for performing a super-resolution on a terminal.

According to the method for an image super-resolution provided by embodiments of the present disclosure, an image super-resolution can be performed based on the lookup table. The deployment of the lookup table-based method is more flexible, and there is no need to deploy a model for an actual testing.

Referring further to FIG. 7, a flow 700 of a third embodiment of a method for an image super-resolution according to the present disclosure is shown. The method for an image super-resolution includes the following steps 701 to 704.

Step 701 includes acquiring a first-resolution target image.

In this embodiment, the specific operation of step 701 is described in detail in step 601 of the embodiment shown in FIG. 6, and is not repeated herein.

Step 702 includes sliding a window on the first-resolution target image by using a preset window to obtain window areas on the first-resolution target image.

In this embodiment, the execution body of the method for an image super-resolution may slide the window on the first-resolution target image by using the preset window to obtain the window areas on the first-resolution target image. Sizes of first-resolution reference images in a set of the first-resolution reference images are the same, and a size of the preset window is equal to the sizes of the first-resolution reference images. For example, the first-resolution reference images in set of the first-resolution reference images is an image consisting of four pixel points, and the size of the preset window may be 4. If the first-resolution target image is a 1×8×8 image, the preset window slides on the first-resolution target image to obtain four window areas with a size of 1×2×2.

Step 703 includes performing a matching between the window areas and the first-resolution reference images in the lookup table to obtain matched second-resolution reference images.

In this embodiment, the execution body may perform the matching between the window areas and the first-resolution reference images in the lookup table to obtain the matched second-resolution reference images. The lookup table may be generated by using the embodiment of the method shown in FIG. 3.

Step 704 includes combining the matched second-resolution reference images to obtain the second-resolution target image.

In this embodiment, the execution body may combine the matched second-resolution reference images to obtain the second-resolution target image. A resolution of the second-resolution target image is N times a resolution of the first-resolution target image.

As can be seen from FIG. 7, the flow 700 of the method for an image super-resolution in this embodiment highlights the steps of searching in the lookup table, compared with the corresponding embodiment of FIG. 6. Thus, the solution described in this embodiment can adapt to a first-resolution target image with any size, and has a wider range of adaptation.

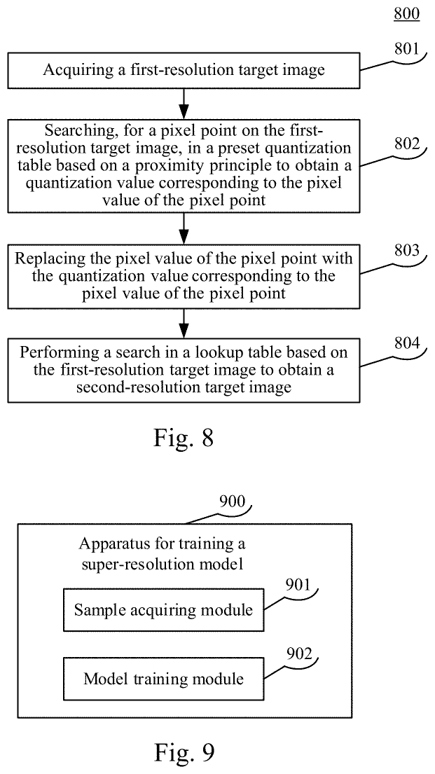

Referring further to FIG. 8, a flow 800 of a fourth embodiment of a method for an image super-resolution according to the present disclosure is shown. The method for an image super-resolution includes the following steps 801 to 804.

Step 801 includes acquiring a first-resolution target image.

In this embodiment, the specific operation of step 801 is described in detail in step 601 of the embodiment shown in FIG. 6, and is not repeated herein.

Step 802 includes searching, for the pixel point on the first-resolution target image, in a preset quantization table based on a proximity principle to obtain a quantization value corresponding to the pixel value of the pixel point.

In this embodiment, for the pixel point on the first-resolution target image, the execution body of the method for an image super-resolution may search the preset quantization table based on the proximity principle to obtain the quantization value corresponding to the pixel value of the pixel point. The quantization value in the preset quantization table is an equal-ratio sequences with a common ratio of M. For example, if the quantization values in the preset quantization table is an equal-ratio sequence with a common ratio of 16, the preset quantization table is 0, 16, 32, . . . , 255. For a pixel point whose pixel value is 123, a corresponding quantization value of 128 can be found according to the proximity principle.

Step 803 includes replacing the pixel value of the pixel point with the quantization value corresponding to the pixel value of the pixel point.

In this embodiment, the execution body may replace the pixel value of the pixel point with the quantization value corresponding to the pixel value of the pixel point, so that the first-resolution target image may be quantized.

Step 804 includes performing a search in a lookup table based on the first-resolution target image to obtain a second-resolution target image.

In this embodiment, the specific operation of step 804 is described in detail in step 602 of the embodiment shown in FIG. 6, and is not repeated herein.

As can be seen from FIG. 8, the flow 800 of the method for an image super-resolution in this embodiment highlights the steps of quantizing an image, compared with the corresponding embodiment of FIG. 6. Thus, the solution described in this embodiment reduces the size of the lookup table, thereby reducing the lookup workload.

Referring further to FIG. 9, as an implementation of the method shown in each of the above figures, the present disclosure provides a first embodiment of an apparatus for training a super-resolution model, and the embodiment of the apparatus corresponds to the embodiment of the method shown in FIG. 1. The apparatus may be particularly applied to various electronic devices.

As shown in FIG. 9, the apparatus 900 for training a super-resolution model may include a sample acquiring module 901 and a model training module 902. The sample acquiring module 901 is configured to acquire training samples, where the training samples include a first-resolution sample image and a corresponding second-resolution sample image, and a resolution of the second-resolution sample image is N times a resolution of the sample of first resolution, N being a positive integer; and the model training module 902 is configured to train an initial network model by using the first-resolution sample image as an input and using the second-resolution sample image as an output, to obtain the super-resolution model.

In this embodiment, the specific processing of the sample acquiring module 901 and the model training module 902 and the technical effects thereof in the apparatus 900 for training a super-resolution model may be described with reference to the related description of steps 101 and 102 in the corresponding embodiment in FIG. 1, and are not repeated herein.

In some alternative implementations of this embodiment, the super-resolution model includes a feature extraction network, a multidimensional convolutional layer and an up-sampling layer, where a dimension of the multidimensional convolutional layer is equal to N and the multidimensional convolutional layer is configured to convolve an input such that a number of channels of an output is N² times a number of a channel of the input, and the up-sampling layer is configured to convert a channel dimension into a spatial dimension.

In some alternative implementations of this embodiment, the model training module 902 is further configured to: input the first-resolution sample image into the feature extraction network to obtain an original feature map; input the original feature map into the multidimensional convolutional layer to obtain a target feature map, where a number of a channel of the target feature map is N² times a number of a channel of the original feature map; input the target feature map into the up-sampling layer to convert the channel dimension into the spatial dimension, to generate a predicted second resolution image; and calculate a loss between the second-resolution sample image and the predicted second resolution image, and adjust a parameter of the initial network model based on the loss, to obtain the super-resolution model.

In some alternative implementations of this embodiment, the apparatus 900 for training a super-resolution model further includes: an image acquiring module configured to acquire a set of a first-resolution reference image; and a super-resolution module configured to input, for the first-resolution reference image in the set of the first-resolution reference images, the first-resolution reference image into the super-resolution model to obtain a second-resolution reference image, and correspondingly storing the first-resolution reference image and the second-resolution reference image into a lookup table, where a resolution of the second-resolution reference image is N times a resolution of the first-resolution reference image.

In some alternative implementations of this embodiment, the image acquiring module is further configured to: acquire a preset quantization table, where a quantization value in the preset quantization table is an equal-ratio sequence with a common ratio of M; and select quantization values in the preset quantization table as pixel values and arbitrarily combining the pixel values to generate the set of the first-resolution reference images.

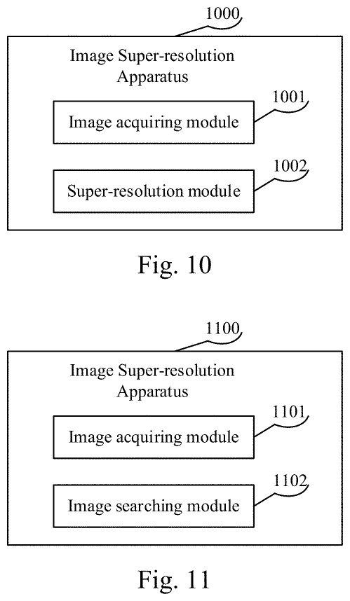

Referring further to FIG. 10, as an implementation of the method shown in each of the above figures, the present disclosure provides a first embodiment of an apparatus for an image super-resolution, and the embodiment of the apparatus corresponds to the embodiment of the method shown in FIG. 5. The apparatus may be particularly applied to various electronic devices.

As shown in FIG. 10, the apparatus 1000 for an image super-resolution may include an image acquiring module 1001 and a super-resolution module 1002. The image acquiring module 1001 is configured to acquire a first-resolution target image; and the super-resolution module 1002 is configured to input the first-resolution target image into a super-resolution model to obtain a second-resolution target image, where a resolution of the second-resolution target image is N times a resolution of the first-resolution target image, and the super-resolution model is trained by using the apparatus shown in FIG. 9.

In this embodiment, the specific processing of the image acquiring module 1001 and the super-resolution module 1002 and the technical effects thereof in the apparatus 1000 for an image super-resolution may be described with reference to the related description of steps 501 and 502 in the corresponding embodiment in FIG. 5, and are not repeated herein.

Referring further to FIG. 11, as an implementation of the method shown in each of the above figures, the present disclosure provides a second embodiment of an apparatus for an image super-resolution, and the embodiment of the apparatus corresponds to the embodiment of the method shown in FIG. 6. The apparatus may be particularly applied to various electronic devices.

As shown in FIG. 11, the apparatus 1100 for an image super-resolution may include an image acquiring module 1101 and an image searching module 1102. The image acquiring module 1101 is configured to acquire a first-resolution target image; and the image searching module 1102 is configured to perform a search in a lookup table based on the first-resolution target image to obtain a second-resolution target image, where a resolution of the second-resolution target image is N times a resolution of the first-resolution target image, and the lookup table is generated by using the apparatus shown in FIG. 9.

In this embodiment, the specific processing of the image acquiring module 1101 and the image searching module 1102 and the technical effects thereof in the apparatus 1100 for an image super-resolution may be described with reference to the related description of steps 601 and 602 in the corresponding embodiment in FIG. 6, and are not repeated herein.

In some alternative implementations of this embodiment, the image searching module 1102 is further configured to: slide a window on the first-resolution target image by using a preset window to obtain window areas on the first-resolution target image, where sizes of first-resolution reference images in a set of the first-resolution reference images are the same, and a size of the preset window is equal to the sizes of the first-resolution reference images; perform a matching between the window areas and the first-resolution reference images in the lookup table to obtain matched second-resolution reference images; and combine the matched second-resolution reference images to obtain the second-resolution target image.

In some alternative implementations of this embodiment, the apparatus 1100 for an image super-resolution further includes: a pixel value quantizing module configured to quantize a pixel value of a pixel point on the first-resolution target image.

In some alternative implementations of this embodiment, the pixel value quantizing module is further configured to: search, for the pixel point on the first-resolution target image, in a preset quantization table based on a proximity principle to obtain a quantization value corresponding to the pixel value of the pixel point, where the quantization value in the preset quantization table is an equal-ratio sequences with a common ratio of M; and replace the pixel value of the pixel point with the quantization value corresponding to the pixel value of the pixel point.

In technical solutions of the present disclosure, the involved processing of user personal information, such as collection, storage, use, processing, transmission, provision and disclosure, is in compliance with the relevant laws and regulations, and do not violate public order and good customs.

According to an embodiment of the present disclosure, the present disclosure further provides an electronic device, a readable storage medium, and a computer program product.

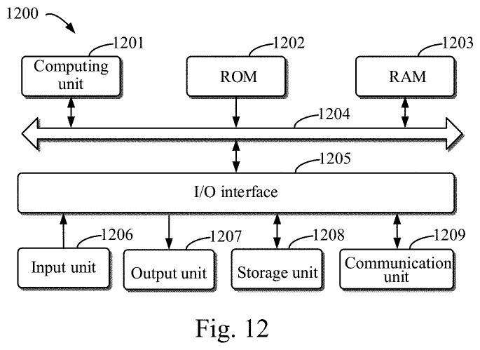

FIG. 12 shows a schematic block diagram of an example electronic device 1200 that may be configured to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may alternatively represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 12, the device 1200 includes a computing unit 1201, which may execute various appropriate actions and processes in accordance with a computer program stored in a read-only memory (ROM) 1202 or a computer program loaded into a random access memory (RAM) 1203 from a storage unit 1208. The RAM 1203 may further store various programs and data required by operations of the device 1200. The computing unit 1201, the ROM 1202, and the RAM 1203 are connected to each other through a bus 1204. An input/output (I/O) interface 1205 is also connected to the bus 1204.

A plurality of components in the device 1200 is connected to the I/O interface 1205, including: an input unit 1206, such as a keyboard and a mouse; an output unit 1207, such as various types of displays and speakers; a storage unit 1208, such as a magnetic disk and an optical disk; and a communication unit 1209, such as a network card, a modem, and a wireless communication transceiver. The communication unit 1209 allows the device 1200 to exchange information/data with other devices through a computer network such as the Internet and/or various telecommunication networks.

The computing unit 1201 may be various general purpose and/or specific purpose processing components having a processing capability and a computing capability. Some examples of the computing unit 1201 include, but are not limited to, a central processing unit (CPU), a graphics processing unit (GPU), various specific purpose artificial intelligence (AI) computing chips, various computing units running a machine learning model algorithm, a digital signal processor (DSP), and any appropriate processor, controller, micro-controller, and the like. The computing unit 1201 executes various methods and processes described above, such as the method for training a super-resolution model and the method for an image super-resolution. For example, in some embodiments, the method for training a super-resolution model and the method for an image super-resolution may be implemented as a computer software program that is tangibly included in a machine readable medium, such as the storage unit 1208. In some embodiments, some or all of the computer programs may be loaded and/or installed onto the device 1200 via the ROM 1202 and/or the communication unit 1209. When the computer program is loaded into the RAM 1203 and executed by the computing unit 1201, one or more steps of the method for training a super-resolution model and the method for an image super-resolution described above may be executed. Alternatively, in other embodiments, the computing unit 1201 may be configured to execute the method for training a super-resolution model and the method for an image super-resolution by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

Program codes for implementing the method of the present disclosure may be compiled using any combination of one or more programming languages. The program codes may be provided to a processor or controller of a general purpose computer, a specific purpose computer, or other programmable apparatuses for data processing, such that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or server.

In the context of the present disclosure, a machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, or a server of a distributed system, or a server combined with a blockchain.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for training a super-resolution model, comprising:
acquiring training samples, wherein the training samples comprise a first-resolution sample image and a corresponding second-resolution sample image, and a resolution of the second-resolution sample image is N times a resolution of the first-resolution sample image, N being a positive integer; and
training an initial network model by using the first-resolution sample image as an input and using the second-resolution sample image as an output, to obtain the super-resolution model.

2. The method according to claim 1, wherein the super-resolution model comprises a feature extraction network, a multidimensional convolutional layer and an up-sampling layer, wherein a dimension of the multidimensional convolutional layer is equal to N and is configured to convolve an input such that a number of channels of an output is N² times a number of a channel of the input, and the up-sampling layer is configured to convert a channel dimension into a spatial dimension.

3. The method according to claim 2, wherein training the initial network model by using the first-resolution sample image as the input and using the second-resolution sample image as the output, to obtain the super-resolution model comprises:
inputting the first-resolution sample image into the feature extraction network to obtain an original feature map;
inputting the original feature map into the multidimensional convolutional layer to obtain a target feature map, wherein a number of channels of the target feature map is N² times a number of a channel of the original feature map;
inputting the target feature map into the up-sampling layer to convert the channel dimension into the spatial dimension, to generate a predicted second resolution image; and
calculating a loss between the second-resolution sample image and the predicted second resolution image, and adjusting a parameter of the initial network model based on the loss, to obtain the super-resolution model.

4. The method according to claim 1, wherein the method further comprises:
acquiring a set of first-resolution reference images; and
inputting, for a first-resolution reference image in the set of first-resolution reference images, the first-resolution reference image into the super-resolution model to obtain a second-resolution reference image, and correspondingly storing the first-resolution reference image and the second-resolution reference image into a lookup table, wherein a resolution of the second-resolution reference image is N times a resolution of the first-resolution reference image.

5. The method according to claim 4, wherein acquiring the set of first-resolution reference images comprises:
acquiring a preset quantization table, wherein quantization values in the preset quantization table is an equal-ratio sequence with a common ratio of M; and
selecting the quantization values in the preset quantization table as pixel values, and arbitrarily combining the pixel values to generate the set of first-resolution reference images.

6. The method according to claim 1, further comprising:
acquiring a first-resolution target image; and
inputting the first-resolution target image into the super-resolution model to obtain a second-resolution target image, wherein a resolution of the second-resolution target image is N times a resolution of the first-resolution target image.

7. The method according to claim 4, further comprising:
acquiring a first-resolution target image; and
performing a search in the lookup table based on the first-resolution target image to obtain a second-resolution target image, wherein a resolution of the second-resolution target image is N times a resolution of the first-resolution target image.

8. The method according to claim 7, wherein performing the search in the lookup table based on the first-resolution target image to obtain the second-resolution target image comprises:
sliding a window on the first-resolution target image by using a preset window to obtain window areas on the first-resolution target image, wherein sizes of first-resolution reference images in the set of first-resolution reference images are the same, and a size of the preset window is equal to the sizes of the first-resolution reference images;
performing a matching between the window areas and the first-resolution reference images in the lookup table to obtain matched second-resolution reference images; and
combining the matched second-resolution reference images to obtain the second-resolution target image.

9. The method according to claim 7, wherein after acquiring the first-resolution target image, the method further comprises:
quantizing a pixel value of a pixel point on the first-resolution target image.

10. The method according to claim 9, wherein quantizing the pixel value of the pixel point on the first-resolution target image comprises:
searching, for the pixel point on the first-resolution target image, in a preset quantization table based on a proximity principle to obtain a quantization value corresponding to the pixel value of the pixel point, wherein quantization values in the preset quantization table is an equal-ratio sequence with a common ratio of M; and
replacing the pixel value of the pixel point with the quantization value corresponding to the pixel value of the pixel point.

11. An electronic device, comprising:
at least one processor; and
a memory storing instructions executable by the at least one processor, the instructions, when executed by the at least one processor, cause the at least one processor to perform operations comprising:
acquiring training samples, wherein the training samples comprise a first-resolution sample image and a corresponding second-resolution sample image, and a resolution of the second-resolution sample image is N times a resolution of the first-resolution sample image, N being a positive integer; and
training an initial network model by using the first-resolution sample image as an input and using the second-resolution sample image as an output, to obtain a super-resolution model.

12. The electronic device according to claim 11, wherein the super-resolution model comprises a feature extraction network, a multidimensional convolutional layer and an up-sampling layer, wherein a dimension of the multidimensional convolutional layer is equal to N and is configured to convolve an input such that a number of channels of an output is N² times a number of a channel of the input, and the up-sampling layer is configured to convert a channel dimension into a spatial dimension.

13. The electronic device according to claim 12, wherein training the initial network model by using the first-resolution sample image as the input and using the second-resolution sample image as the output, to obtain the super-resolution model comprises:
inputting the first-resolution sample image into the feature extraction network to obtain an original feature map;
inputting the original feature map into the multidimensional convolutional layer to obtain a target feature map, wherein a number of channels of the target feature map is N² times a number of a channel of the original feature map;
inputting the target feature map into the up-sampling layer to convert the channel dimension into the spatial dimension, to generate a predicted second resolution image; and
calculating a loss between the second-resolution sample image and the predicted second resolution image, and adjusting a parameter of the initial network model based on the loss, to obtain the super-resolution model.

14. The electronic device according to claim 11, wherein the operations further comprise:
acquiring a set of first-resolution reference images; and
inputting, for a first-resolution reference image in the set of first-resolution reference images, the first-resolution reference image into the super-resolution model to obtain a second-resolution reference image, and correspondingly storing the first-resolution reference image and the second-resolution reference image into a lookup table, wherein a resolution of the second-resolution reference image is N times a resolution of the first-resolution reference image.

15. The electronic device according to claim 14, wherein acquiring the set of first-resolution reference images comprises:
acquiring a preset quantization table, wherein quantization values in the preset quantization table is an equal-ratio sequence with a common ratio of M; and
selecting the quantization values in the preset quantization table as pixel values, and arbitrarily combining the pixel values to generate the set of first-resolution reference images.

16. The electronic device according to claim 11, wherein the operations further comprise:
acquiring a first-resolution target image; and
inputting the first-resolution target image into the super-resolution model to obtain a second-resolution target image, wherein a resolution of the second-resolution target image is N times a resolution of the first-resolution target image.

17. The electronic device according to claim 14, wherein the operations further comprise:
acquiring a first-resolution target image; and
performing a search in the lookup table based on the first-resolution target image to obtain a second-resolution target image, wherein a resolution of the second-resolution target image is N times a resolution of the first-resolution target image.

18. The electronic device according to claim 17, wherein performing the search in the lookup table based on the first-resolution target image to obtain the second-resolution target image comprises:
sliding a window on the first-resolution target image by using a preset window to obtain window areas on the first-resolution target image, wherein sizes of first-resolution reference images in the set of first-resolution reference images are the same, and a size of the preset window is equal to the sizes of the first-resolution reference images;
performing a matching between the window areas and the first-resolution reference images in the lookup table to obtain matched second-resolution reference images; and
combining the matched second-resolution reference images to obtain the second-resolution target image.

19. The electronic device according to claim 17, wherein after acquiring the first-resolution target image, the operations further comprise:
quantizing a pixel value of a pixel point on the first-resolution target image.

20. A non-transitory computer readable storage medium storing computer instructions, wherein the computer instructions when executed by a computer cause the computer to perform operations comprising:
acquiring training samples, wherein the training samples comprise a first-resolution sample image and a corresponding second-resolution sample image, and a resolution of the second-resolution sample image is N times a resolution of the first-resolution sample image, N being a positive integer; and
training an initial network model by using the first-resolution sample image as an input and using the second-resolution sample image as an output, to obtain the super-resolution model.
